(19) United States
(12) Patent Application Publication
(10) Pub. No.: US 2012/0276886 A1
(43) Pub. Date: Nov. 1, 2012

(54) Method and Apparatus for Acquiring Information Related to a Position

(75) Inventors: Kimmo Marko Tapani Alanen, Lempaala (FI); Jari Tapani Syrjarinne, Tampere (FI)

(73) Assignee: NOKIA CORPORATION, Espoo (FI)

(21) Appl. No.: 13/139,849

(22) PCT Filed: Dec. 23, 2008
(86) PCT No.: PCT/IB2008/003614

§ 371 Date: Jun. 15, 2011

(51) Int. Cl. H04W 4/02

(52) U.S. Cl. 455/418

(57) ABSTRACT

In accordance with an example embodiment of the present invention, a method and an apparatus are shown comprising receiving status information of an apparatus, and determining a probability for an update of information related to a position being obtained based on the status information. Based on the determined probability and an elapsed time since a last update of the information related to a position, it is determined whether to activate a receiver in order to obtain the update of information related to a position.

### TECHNICAL FIELD

The present application relates generally to methods and apparatuses for acquiring information related to a position. The application also relates to updating location information at intervals and determining conditions for a suitable time for an update.

### BACKGROUND

Positioning technologies are more and more widespread in modern apparatuses. They may be used in specialized devices for navigation systems, for example automotive navigation systems used in cars, or they may be used in apparatuses in which the positioning technologies add a support functionality, for example in a digital camera where location information may be attached to the metadata of a digital image in order to retrieve the location at which a photo was taken. Further, positioning technologies may be used in mobile apparatuses such as personal digital assistants (PDAs) or mobile phones, where they add functionality to applications such as a route planner or enable new applications.

### SUMMARY

Various aspects of examples of the invention are set out in the claims.

According to a first aspect of the present invention, a method is shown comprising receiving status information of an apparatus and determining a probability for an update of information related to a position being obtained based on the status information. It is determined whether to activate a receiver in order to obtain the update of information related to a position based on the determined probability and an elapsed time since a last update of the information related to a position.

According to a second aspect of the present invention, an apparatus is disclosed comprising a controller configured to receive status information from the apparatus. The controller is further configured to determine a probability for an update of information related to a position being obtained based on the status information. The controller is further configured to determine whether to activate a receiver in order to obtain the update of information related to a position based on the determined probability and an elapsed time since a last update of the information related to a position. The controller is further configured to activate the receiver at the determined time.

According to a third aspect of the present invention, a computer program, a computer program product and a computer readable medium are disclosed comprising instruction that, when executed by a computer, perform receiving status information of an apparatus, determining a probability for an update of information related to a position being obtained based on the status information, and determining whether to activate a receiver in order to obtain the update of information related to a position based on the determined probability and an elapsed time since a last update of the information related to a position.

According to a fourth aspect of the present invention, an apparatus is shown comprising means for receiving status information of an apparatus, means for determining a probability for an update of information related to a position being obtained based on the status information, and means for determining whether to activate a receiver in order to obtain the update of information related to a position based on the determined probability and an elapsed time since a last update of the information related to a position.

### BRIEF DESCRIPTION OF THE DRAWINGS

For a more complete understanding of example embodiments of the present invention, reference is now made to the following descriptions taken in connection with the accompanying drawings in which:

FIG. 1a shows a system comprising an apparatus according to an example embodiment of the invention;

FIG. 1b shows a system comprising an apparatus and an accessory according to an example embodiment of the invention;

FIG. 2 shows a block diagram of an apparatus according to an example embodiment of the invention;

FIG. 3 illustrates a system view of an apparatus according to an example embodiment of the invention;

FIG. 4 is a flowchart illustrating a method for updating information related to a position according to an example embodiment of the invention; and

FIG. 5 is a flowchart illustrating a method using polling for updating information related to a position according to an example embodiment of the invention.

### DETAILED DESCRIPTION OF THE DRAWINGS

Mobile apparatuses may use positioning technologies in applications such as route planners and trackers and so on. While such an application is running, location information may be tracked constantly. When an application using location information is started, it may take some time to receive information required to determine a first position based on location information. For example, in a global positioning system (GPS) that provides location information to determine a position based on satellite signals, data messages are sent by the satellites in frames, each taking 30 seconds in order to transmit 1500 bits. The data messages may comprise information on the satellite clock and its relationship to GPS time. The data messages may further comprise ephemeris data, which gives the satellite's own precise orbit. Ephemeris data may be valid for 2 hours. Therefore, an update of ephemeris data may need to be received in regular or irregular intervals. The time required to receive the ephemeris data may contribute to the time needed for the determination of a first position. Thus, the time to determine a first position may be 30 seconds or more, if the ephemeris data in the apparatus is outdated. The time to determine a first position may be faster, if the ephemeris data in the apparatus is still valid.

When ephemeris data hasn't been received for some time, a method using a synthetic ephemeris may be used, which may extend the life-time of the ephemeris stored in the apparatus. The synthetic ephemeris may be determined for example based on accurate force models of the satellite orbits. With this method, a position engine may be able to calculate a fix for the ephemeris. Thus, a first position may be calculated faster based on the synthetic ephemeris than update information of the ephemeris would be received. An application using location information may therefore be started more quickly, for example a navigation application. The accuracy of the fix using this synthetic ephemeris may be worse than the fix using up-to-date ephemeris, because the accuracy of the synthetic ephemeris may degrade over time. The rate of degradation may depend linearly on the age of the original ephemeris used in the synthesis.

The acquisition of the GPS signals is a search of the satellite signals within a space formed by different pseudo-random numbers (PRN) which may be satellite specific, different code phases based on a point in time, and different frequencies. The frequency search space may be related to the fact that, inside the position engine, the absolute frequency of the oscillator may not be known exactly. An uncertainty of the frequency may be caused by the temperature dependency of a frequency from a crystal oscillator. Using temperature sensing crystal oscillators (TSXOs) may overcome the temperature dependency to some degree. The temperature is measured, and a frequency correction based on the measured temperature may be applied to the crystal oscillator. A table containing offset values for a range of temperatures may be stored in the apparatus. However, the temperature dependency of the crystal oscillator may change over time. The temperature dependency may also be not known for temperatures for which an offset value is not stored in the apparatus, and an interpolation or extrapolation from known values may not give an accurate result.

The acquisition of the GPS signals may be constrained by obstacles in the signal propagation of the satellite signals, for example by objects such as buildings in urban areas or the like. Further, indoor reception may often be poor, so that a position may not be determined Assisted GPS (A-GPS) may be used to provide location information or to assist GPS signal acquisition. A-GPS may use information within a cellular network in order to assist an apparatus, for example a mobile phone, in determining a position. For example, a cellular network may have information about the position of a mobile phone based on the cell in which the mobile phone is located. The cellular network may also provide orbital data of the satellites and reference time assistance to the mobile phone that may allow the mobile phone to calculate the expected code phases and Doppler frequencies for the satellites to speed up signal acquisition and eventually position calculation. A-GPS may require a data connection to the cellular network. As a data connection to a cellular network may involve additional cost, a mobile phone may not have A-GPS enabled. A user of the phone may not want to enable A-GPS in order to avoid the additional cost, or the user may not know about the availability of A-GPS in the apparatus.

When A-GPS is not used, further measures may be taken in order to prevent the ephemeris data from becoming outdated. For example, a GPS receiver in the apparatus may be switched on in regular or irregular intervals in order to obtain ephemeris data. Activating the GPS receiver in intervals may therefore increase the speed of the determination of a first position when an application using location information is started. Activating the GPS receiver in intervals may however increase overall power consumption of the apparatus.

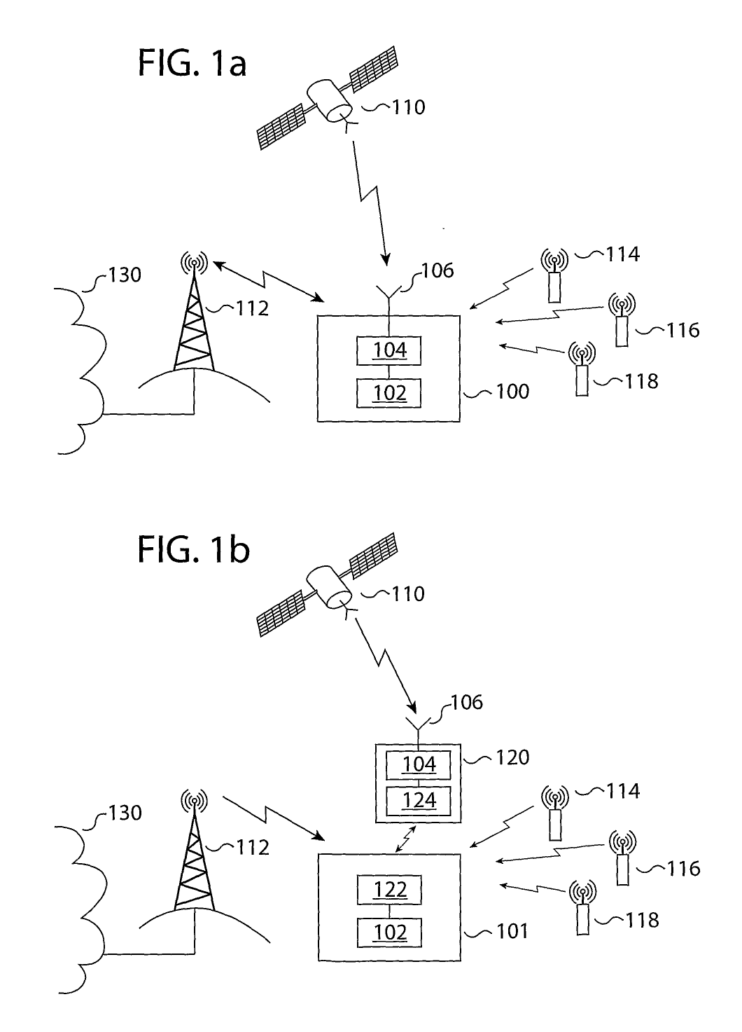

Example embodiments of the present invention and their potential advantages are best understood by referring to FIGS. 1 through 5 of the drawings.

FIG. 1a shows a system comprising an apparatus 100 according to an example embodiment of the invention. Apparatus 100 comprises a positioning engine 102. Apparatus 100 further comprises a module configured to receive data from a global positioning satellite system, for example GPS module 104. GPS module 104 is configured to receive data signals from satellite 110 with antenna 106. The positioning engine 102 may be configured to receive GPS data from GPS module 104 and provide location information to other applications within apparatus 100. Apparatus 100 may also be configured to receive signals from a cellular transmitter 112. Cellular transmitter 112 may be coupled to a network 130. In an example embodiment, apparatus 100 may negotiate assistance data with the network 130. The positioning engine 102 may further be configured to provide location information to an application residing in a server of the network 130 or of the Internet. Apparatus 100 may further be configured to receive signals from local transmitters 114, 116 and 118. Apparatus 100 may further comprise one or more sensors to detect a condition or a change in a condition in the environment of apparatus 100. Apparatus 100 may further be configured to detect a state or a change of a state of apparatus 100, for example a change in a connection to one of the local transmitters 114, 116 or 118, a connection to a charger, a selected profile of apparatus 100, or the like.

FIG. 1b shows a system comprising an apparatus 101 and an accessory 120 according to an example embodiment of the invention. In this example embodiment, GPS module 104 is part of accessory 120 that is connected to apparatus 101 by a wireless data connection, for example by a short range radio transmission such as a Bluetooth™ connection. Apparatus 101 comprises a wireless data module 122, accessory 120 comprises a complementary wireless data module 124. GPS data is forwarded from GPS module 104 in accessory 120 to wireless data module 124. From wireless data module 124 the GPS data is transmitted to the complementary wireless data module 122 in apparatus 101. The complementary wireless data module 122 then forwards the GPS data to a positioning engine 102 in apparatus 101. Apparatus 101 may also be configured to receive signals from a cellular transmitter 112. Cellular transmitter 112 may be coupled to a network 130. In an example embodiment, apparatus 101 may negotiate assistance data with the network 130. The positioning engine 102 may further be configured to provide location information to an application residing in a server of the network 130 or of the Internet. Apparatus 101 may further be configured to receive signals from local transmitters 114, 116 and 118. Apparatus 101 may further comprise one or more sensors to detect a condition or a change in a condition in the environment of apparatus 101. Apparatus 101 may further be configured to detect a state or a change of a state of apparatus 101, for example a change in a connection to one of the local transmitters 114, 116 or 118, a connection to a charger, a selected profile of apparatus 101, or the like.

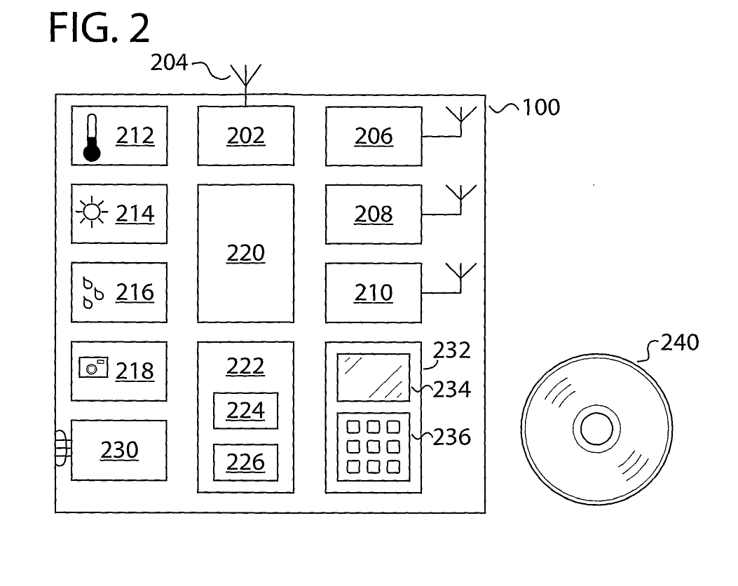

FIG. 2 shows a block diagram of an apparatus 100 or 101 according to an example embodiment of the invention. Apparatus 100 comprises a receiver 202 configured to receive signals from satellites of a global navigation satellite system, for example GPS, GLONASS (Global Navigation Satellite System), Galileo, QZSS (Quasi-Zenith Satellite System), SBAS (Satellite Based Augmentation System), Compass, Beidou and/or the like, through antenna 204. Data received by the receiver 202 is processed by controller 220. Controller 220 also controls the activity of receiver 202. Apparatus 100, 101 comprises a storage or memory 222. Memory 222 may comprise volatile memory 224, for example random access memory (RAM), and non-volatile memory 226, for example read only memory (ROM) or Flash memory. Non-volatile memory 226 may store a computer program comprising instructions to control receiver 202 and to process data from receiver 202. Memory 226 may further store computer instructions for a location service providing location information. Memory 226 may further store one or more applications, for example applications using location information. The computer program and applications may be stored on a computer-readable medium 240, for example a magnetic or optical computer-readable medium, such as a compact disc (CD), a digital versatile disc (DVD), a floppy disc or any other computer-readable medium such as a memory stick and/or the like.

In an example embodiment, apparatus 100, 101 comprises one or more cellular transceivers 206, for example a transceiver for the Global System for Mobile communication (GSM), the Universal Mobile Telecommunication System (UMTS), a wideband code division multiple access system (W-CDMA), or any other cellular system for mobile communication. The cellular transceiver 206 may be used for A-GPS. Apparatus 100, 101 may further comprise one or more broadcast receivers 208, for example a broadcast receiver for digital video broadcasting handheld (DVB-H), for digital audio broadcasting (DAB), digital media broadcasting (DMB), or for a Forward-Link-Only (MediaFLO™) system. Apparatus 100, 101 may comprise one or more local transceivers 210, for example a transceiver according to the Bluetooth™ standard, a wireless local area network (W-LAN) transceiver, a “wireless fidelity” (WiFi) transceiver, a radio frequency identification (RF-ID) transceiver, or a transceiver according to any other short range transmission standard. Apparatus 100, 101 may further comprise one or more local transmitters, for example a frequency modulation transmitter (FM-transmitter).

In a further example embodiment, apparatus 100, 101 comprises one or more sensors, for example a temperature sensor 212, a light sensor 214, a humidity sensor 216, a camera 218, or any other sensor such as an accelerometer to detect a motion or a magnetometer to detect a direction.

Apparatus 100, 101 may also comprise one or more wired interfaces 230 and a user interface (UI) module 232 comprising a display 234 and a keypad 236 in order to interact with a user of the apparatus. The user interface 232 may further comprise a microphone, for example for speech input, and a loudspeaker for sound output.

Controller 220 may control transceivers, transmitters and receivers 206, 208 and 210, sensors 212, 214, 216 and 218, wired interface 230, and the UI module 232. Controller 220 may also receive status information of apparatus 100 or 101, for example status information from the controlled parts of apparatus 100. Controller 220 may further receive status information received by a cellular transceiver 206, a receiver 208, a local transceiver 210, or a wired interface 230. Received status information may be received, for example, from a remote sensor or an accessory.

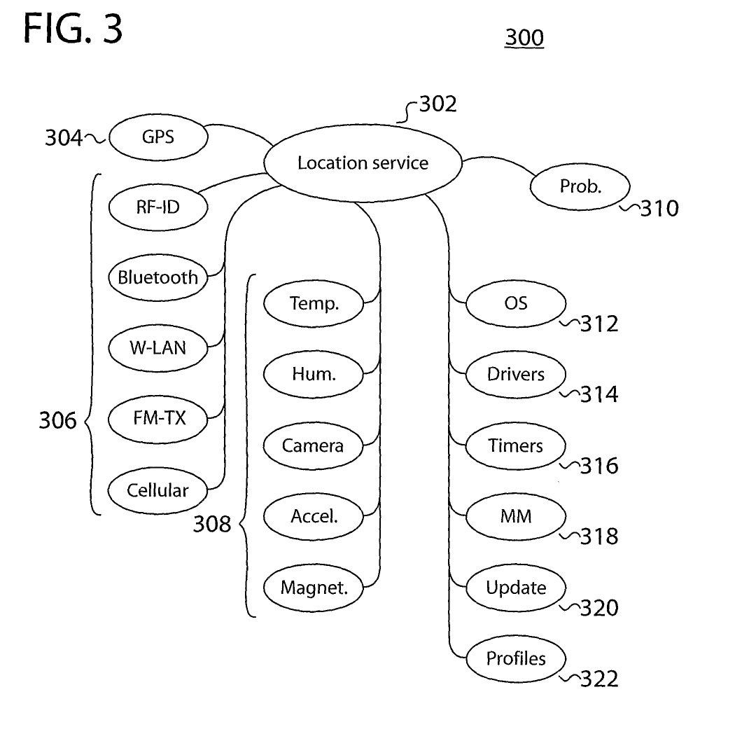

FIG. 3 illustrates a system view of a positioning engine 300 that may be implemented in an apparatus 100, 101 according to an example embodiment of the invention. Controller 220 may be configured to run a location service 302 in order to provide location information to other applications, for example a navigation application. Location service 302 may be active when no application requiring location information is running. Location service 302 may be active in order to update location information. Location service 302 may also be active in order to update ephemeris data. Ephemeris data may be received from a global navigation satellite system, for example by GPS module 304.

Location service 302 may determine whether GPS module 304 shall be activated in order to receive ephemeris data. Location service 302 may further determine a time when GPS module 304 shall be activated. The determination may be based on the time when ephemeris data becomes outdated. The determination may further be based on the time when ephemeris data was last received or known to be valid. Location service 302 may determine whether and when to activate the GPS module 304 based on a change in a condition of apparatus 100, 101. A change in a condition of apparatus 100, 101 may comprise a change in an activity of one of the transmitter/receiver modules 306, for example an RF-ID module, a Bluetooth™ module, a W-LAN module or an FM transmitter.

In an example embodiment, a W-LAN module reports high radio signal strength information (RSSI) values for a high number of W-LAN stations. For example, the signal from more than five W-LAN stations has an RSSI value classified as “very good”. Location service 302 may use a probability function 310 to determine that the probability to receive ephemeris data may be low, as a high number of W-LAN stations may serve as an indication that the apparatus is indoors or in an urban area where line-of-sight to many satellites may be obstructed. Location service may therefore decide not to activate GPS module 304 now, but at a later time.

A probability may be represented by a number value. For example, a probability may be represented by a value between 0 and 1. A probability may be high, if it is above a predetermined threshold. A probability may be low, if it is below another predetermined threshold. The predetermined threshold to determine a high probability and the other predetermined threshold to determine a low probability may be different or the same.

In a further example scenario, location service 302 determines high RSSI values for a high number of W-LAN stations. Location service 302 further determines that ephemeris data is outdated. For example, an update of ephemeris data was received more than 2 hours ago. Thus, location service 302 may decide to activate the GPS module 304 to receive new ephemeris data. If however no ephemeris data is received after the activation, location service 302 may determine not to activate GPS module 304 for a certain time. For example, location service 302 may determine not to activate GPS module 304 for 10 minutes, or location service 302 may determine not to activate GPS module 304 until status information of the apparatus is received again.

In a further example embodiment, the W-LAN module reports no signal with a high RSSI value. This may be interpreted as an indication that the apparatus is outdoors in a rural area. Location service 302 may thus conclude that the probability to receive ephemeris data is high and activate GPS module 302.

In an example embodiment, the W-LAN module reports a connection to a W-LAN transmitter. Location service 302 may try to receive location information from the W-LAN transmitter through the W-LAN module. Location service 302 may also try to receive information related to one or more GPS signal from the W-LAN transmitter. Information related to a GPS signal may aid in acquiring the satellite signals or in extending the lifetime of a synthetic ephemeris. Information related to the GPS signals may also describe line-of-sight visibility of the satellites in a reception area covered by the W-LAN transmitter. Depending on the information received from the W-LAN transmitter, location service 302 may decide when to activate GPS module 304 in order to receive a new update of the ephemeris data from the satellites.

In an example embodiment, a Bluetooth™ module reports status information, for example a change in a condition. For example, the Bluetooth™ module reports a connection using the SIM (subscriber identification module) access profile (SAP) defined by the Bluetooth™ standard. As this profile is frequently used in cars, the location service 302 determines that the probability to receive ephemeris data may be high, as the apparatus may be outdoors or in a car where the chance to have a good line-of-sight visibility to the satellites is high. When the car is moving, the probability to receive ephemeris data within a certain time period may change compared to the stationary case. In an example embodiment, no information related to a position is received in the stationary case. If the SIM access profile (SAP) is activated, the probability to receive information related to a position may increase. In a further example embodiment, information related to a position is received in the stationary case. If the SIM access profile (SAP) is activated, the probability to receive information related to a position may decrease. In this situation, a varying reception quality in a moving car may result in a lower probability.

In an example embodiment, the change in a condition of the apparatus is the activation of an FM transmitter (FM-TX). As in the Bluetooth™-SAP example, activation of the FM transmitter may be an indication that the apparatus is used in a car environment. Thus, the location service 302 determines that the probability to receive ephemeris data may be high and decide to activate GPS module 304 in order to receive an update of the ephemeris data from the satellites. If, however, ephemeris data was received only recently, for example within the last 30 minutes, location service 302 may decide to activate GPS module 304, for example at a certain point in time in the future, such as “in 10 minutes”.

In an example embodiment, location service 302 may not wait until a change in a condition occurs, but it may query transmitter/receiver modules 306, in order to obtain information of a current state of at least one of the transmitter/receiver modules 306. For example, location service 302 may query the W-LAN module whether it is coupled to a W-LAN transmitter. Location service 302 may query the Bluetooth™ module whether it is in a connection using the SAP profile. Location service 302 may query the FM transmitter whether it is active. Based on the received information, location service 302 may determine a probability for an update of ephemeris data being obtained. Location service 302 may use the probability function 310 for the determination.

In an example embodiment, a cellular transceiver reports a handover from one base station to another base station. Location service 302 may use a probability function 310 to determine that the probability to receive ephemeris data may be high, as the apparatus may be moving, for example in a means of transport like a car, a bicycle, a train and the like. The location service may determine that there is a higher likelihood that the apparatus is moving in a means of transport, when more than one handover between different cells are reported within a certain time frame, for example at least 2 handovers between different cells within 5 minutes. Location service may therefore decide to activate GPS module 304 to receive new ephemeris data. If, however, ephemeris data was received only recently, for example within the last 10 minutes, location service 302 may decide to activate GPS module 304, for example at a certain point in time in the future, such as “in 5 minutes”. If however no ephemeris data may be received, location service 302 may determine not to activate GPS module 304 for a certain time. For example, location service 302 may determine not to activate GPS module 304 for 10 minutes, or location service 302 may determine not to activate GPS module 304 until another change in a condition of the apparatus is detected.

In a further example embodiment, the determined probability is based on the information from more than one of the transmitter/receiver modules 306. For example, the W-LAN module may report that it is not coupled to a W-LAN transmitter. The Bluetooth™ module may report a connection using the SAP profile, and the FM transmitter may report an FM transmission activity. As all factors taken individually indicate a high probability that ephemeris data may be received, a cumulative probability taking all 3 factors into account may be higher than any of the individual probabilities. Individual probabilities may be given a weighting or weighting factor in order to determine the cumulative probability.

In an example embodiment, the determined probability is based on information received from one or more sensor modules 308, such as a temperature sensor module, a humidity sensor module, a camera module, an accelerometer module, a magnetometer module, or another sensor module. For example, the temperature module sends information to the location service of a measured temperature of 5° C. A low temperature may indicate that the apparatus is used outdoors. Thus, the location service 302 may determine that the probability to receive ephemeris data may be high. Location service 302 may further use information stored in the apparatus or supplied by other applications running on controller 220 to determine the probability. For example, a calendar application may indicate that it is December, and that a time zone of GMT (Greenwich Mean Time)+2 hours is currently installed. A telephone application may further indicate that the apparatus is booked into a Finnish telephone system. Thus, the determined probability may be increased as there is a high likelihood that the apparatus is used outdoors.

In an alternative scenario, the measured temperature is again 5° C. The calendar application may indicate that it is December, and that a time zone of GMT+7 hours is currently used. A telephone application may further indicate that the apparatus is booked into a Thai telephone system. Therefore, the location service 302 may determine that the apparatus is not used outdoors. Thus, the location service 302 may determine that the probability to obtain an update of ephemeris data may be low.

In an example embodiment, the measured temperature changes. The location service 302 may determine that the apparatus is moved, for example in an outdoor environment. Thus, the determined probability may be high as there is a high likelihood that the apparatus is used outdoors.

In an example embodiment, a light reading from a light sensor or a camera changes. The location service 302 may determine that the apparatus is moved, for example in an outdoor environment. Thus, the determined probability may be high as there is a high likelihood that the apparatus is used outdoors.

In an example embodiment, a light measurement from a light sensor or a camera indicates a modulated light. Modulated light, for example light modulated at a frequency of 50 Hz (Hertz), may be typical of artificial light sources, such as light bulbs or fluorescent lamps. Thus, the determined probability may be low as there is a high likelihood that the apparatus is used indoors. In an example embodiment, a color temperature of a scene determined by a camera is detected. For example, a color temperature typical of incandescent or fluorescent light is detected. In an example scenario, the time of the day is 2 o'clock p.m. The location service 302 may have the information on the time of the day. The location service 302 may determine a high likelihood that the apparatus is used indoors, as incandescent or fluorescent light is likely to be found indoors at this time of the day. Thus, the location service 302 may determine that the probability to obtain an update of ephemeris data may be low.

In an example embodiment, the determined probability is based on an accelerometer module and a magnetometer module. The accelerometer module has not reported any acceleration since a last update of ephemeris data. Thus, the location service 302 may determine that no movement has taken place since the last update of ephemeris data. Location service 302 further determines that ephemeris data was received more than 30 minutes ago. Thus, location service 302 may determine that there is a high probability to obtain an update of ephemeris data and decide to activate the GPS module 304 to receive the new update of ephemeris data.

In a further example embodiment, location service 302 has not received sufficient information from the satellite signals to update location information. Location service may use information from the accelerometer sensor and the magnetometer sensor to determine an update of the location information. For example, information from the accelerometer sensor and the magnetometer sensor are related to a time in order to determine at least one displacement vector from a last known position, for example a position which was determined from information from the satellite signals.

In a further example embodiment, the determined probability is based on the information from one or more of the transmitter/receiver modules 306 and/or from one or more of the sensor modules 308. For example, an FM transmitter (FM-TX) is activated. A short time later, for example five minutes later, the accelerometer module reports an acceleration to or a speed of 100 km/h. A light sensor may further report a quickly changing illumination. Based on at least this information, the location service 302 may determine that the probability to receive an update of ephemeris data may be high, as the reported information corresponds to a usage in a car. Based on the determined probability and the elapsed time since a last update the location service may activate GPS module 304 to receive the new update of ephemeris data.

Information from other sensor may further assist the location service 302 to determine a probability to receive an update of ephemeris data. For example, information from a humidity sensor may assist the location service 302 to determine whether the apparatus is indoors or outdoors. Information from a camera may assist the location service 302 to determine whether the apparatus is moving. Images from a camera may also be used to extract information on the environment of the apparatus. The determined or extracted information may be used to determine a probability to receive an update of ephemeris data.

The location service 302 may receive information from at least one of the transmitters/receivers 306 and/or at least one of the sensors 308 to determine that the probability to receive an update of ephemeris data may be high or low. The location service 302 may apply one or more weighting factors to received information from transmitters/receivers 306 and/or sensors 308. Thus, probability function 310 may be used by location service 302 to determine a combined probability based on the received information including the one or more weighting factors.

The location service 302 may further interact with an Operating System (OS) 312 of the device and use operation system functions like drivers 314, timers 316, and a memory management (MM) unit 318. The location service 302 may also use an update function 320 in order to update the probability function 310 and/or the rules according to which a probability to receive an update of ephemeris data is determined. Further, the update function 320 may be used to add new rules or probability functions, for example to support new or added transmitters/receivers and/or sensors. New or added transmitters/receivers and/or sensors may be coupled to apparatus 100 or 101 for example on an accessory interface, such as wired interface 230, or on a wireless interface, such as one of local transceivers 210.

In an example embodiment, location service 302 provides location information to the operating system 312 or to other applications. Other application may request location information from the location service 302 or from the operating system 312.

In a further example embodiment, location service 302 receives information on a change in a device profile. For example, a device profile of the apparatus is set to “Outdoors”. Location service 302 may receive the profile information from operating system 312, or a service or an application controlling the device profiles 322. Location service 302 may receive the information on device profiles for example in response to a polling request to the service or application controlling the device profiles 322, or in response to a subscription to the profile service 322. Thus, location service 302 may determine that the probability to receive an update of ephemeris data may be high, as the probability to have a direct line-of-sight to the satellites may be higher outdoors than indoors. Based on the determined probability and the elapsed time since a last update the location service may activate GPS module 304 to receive the new update of ephemeris data.

In a further example embodiment, location service 302 receives information that a charger is plugged in. This may mean that the apparatus is indoors or in a car. The location service 302 may receive information from at least one of the transmitters/receivers 306 and/or at least one of the sensors 308 to determine that the probability to receive an update of ephemeris data may be high or low. The location service 302 may activate GPS module 304 to receive an update of ephemeris data, as there is sufficient power when the apparatus is in a state of charging. Further, the apparatus may use longer integration times to improve ephemeris data demodulation, for example from attenuated satellite signals.

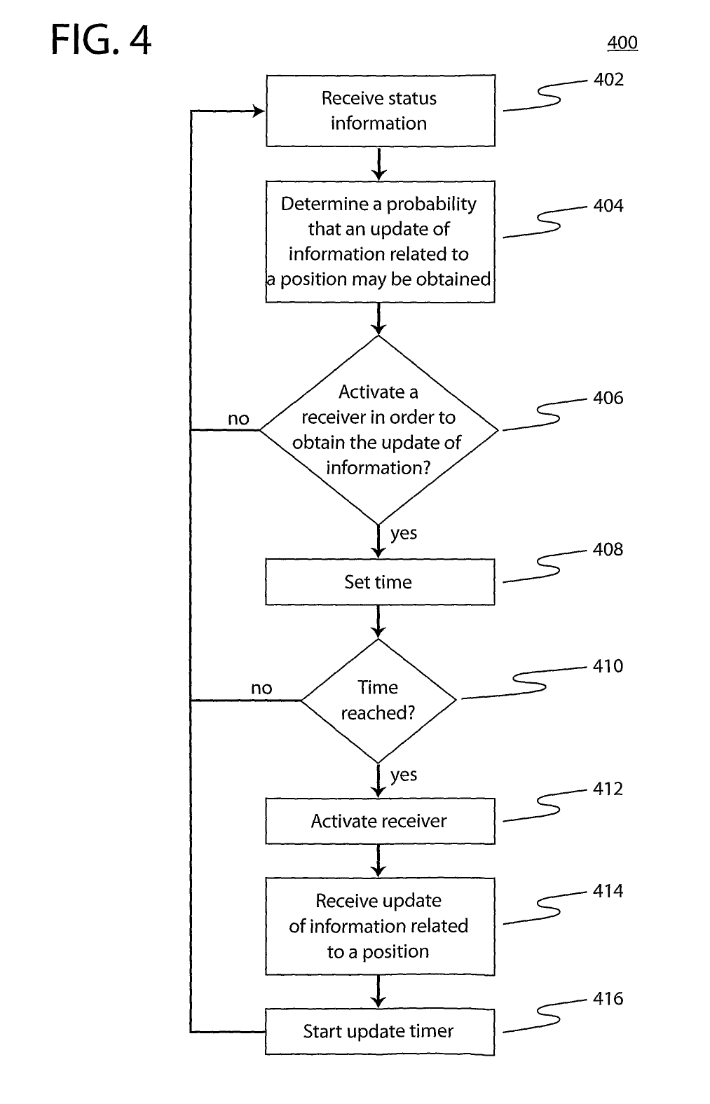

FIG. 4 is a flowchart illustrating a method 400 for updating information related to a position according to an example embodiment of the invention. At block 402, status information is received, for example of an apparatus 100 or 101. Status information may be related to the apparatus, to a cellular transceiver, to a short range transceiver, receiver and/or transmitter, to a sensor such as a light sensor, a camera, a humidity sensor, a temperature sensor, an acceleration sensor, a magnetometer, or the like. Status information may also relate to a software status of a process or an application executed within the apparatus. Status information may relate to a state, for example an active profile, or it may relate to a change of a state, for example an activation of a short range radio connection, such as a Bluetooth™ connection. Status information may be received from a single source or from two or more sources of information, such as the hard- and/or software blocks named above.

At block 404, the status information is used to determine a probability for an update of information related to a position being obtained. For example, a probability may be determined whether a reception condition of one or more satellites of a global navigation satellite system is sufficient to receive the signals transmitted by the satellites. For example, a probability may be determined whether there is a good line-of-sight connection to one or more satellites. This may depend on whether the apparatus is used outside or inside.

At block 406, it is determined whether to activate a receiver in order to obtain the update of information related to a position. The determination may be based on the determined probability and the elapsed time since a last update of the information related to a position was received. If it is determined not to activate the receiver, the method returns to step 402 and waits for another reception of status information. If it is determined to activate the receiver, a time may be determined when to activate the receiver in step 408. For example, a time of 12 minutes may be set. In another example, a time of zero may be set, so that the receiver may be activated immediately. The determination of the time may depend on the determined probability and the elapsed time since a last update of the information related to a position was received. In an example scenario, the apparatus may determine that there is a high probability to receive an update of information related to a position from a satellite, for example to receive ephemeris data. However, the last update may have been received only 5 minutes ago. Thus, at block 406 it may be decided to receive an update of ephemeris data in 12 minutes, A timer may be set accordingly.

At block 410, it is checked whether the determined time is reached. For example, it may be checked whether the timer has expired. For example, it may be checked whether 12 minutes have passed since the decision was made to receive an update of ephemeris data.

If the determined time is not reached, the method 400 returns to block 402 in order to receive further status information. If further status information is received at block 402, the probability for an update of information related to a position being obtained may be determined again at block 404. Based on the again determined probability, also the time when to activate the receiver in order to obtain the update of information related to a position may be re-determined. At block 406 it is determined whether to activate the receiver. At block 408 a time is set, and at block 410 it is then again determined whether the (re-)determined time is reached.

When the time is reached at block 410, the receiver is activated at block 412. For example, the receiver to receive one or more satellite signals of the global navigation satellite system may be activated, such as receiver 104 of apparatus 100 in FIG. 1a, or receiver 104 of accessory 120 in FIG. 1b. At block 414 an update of information related to a position is received, for example an update of, ephemeris data. At block 416 an update timer may be started. The update timer may be used to keep track of the time since the last update of information related to a position.

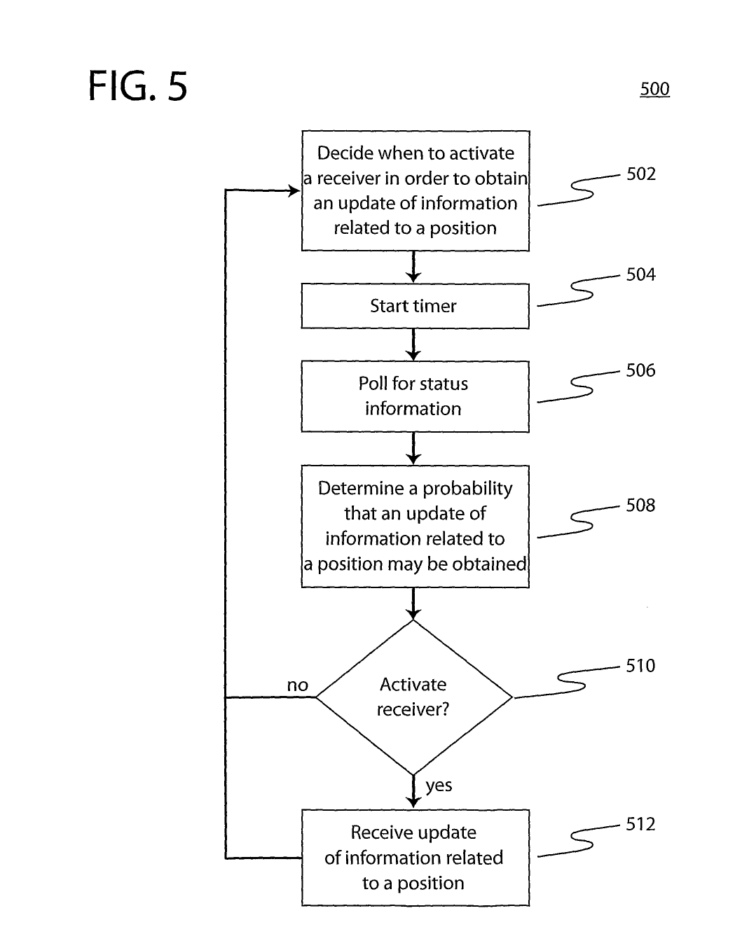

FIG. 5 is a flowchart illustrating a method 500 using polling for updating information related to a position according to an example embodiment of the invention. At block 502 a time is determined when to activate a receiver in order to obtain an update of information related to a position. The decision may be based on a time of a last update of information related to a position. The decision may also be based on a last determination of a probability that an update of information related to a position may be obtained. At block 504 a timer is started accordingly. When the timer indicates that the determined time has elapsed, status information is polled at block 506. Status information may be received from one or more of the polled blocks. Status information may be polled related to the apparatus, to a cellular transceiver, to a short range transceiver, receiver and/or transmitter, to a sensor such as a light sensor, a camera, a humidity sensor, a temperature sensor, an acceleration sensor, a magnetometer, or the like. Status information may also be polled from a process or an application executed within the apparatus. Status information may relate to a state, for example an active profile, or it may relate to a change of a state, for example an activation of a short range radio connection, such as a Bluetooth™ connection. Status information may be polled from a single source or from more than one sources of information, such as the hard- and/or software blocks named above.

The decision to poll a hard- or software block may depend on the polling result of one or more earlier polled blocks. In an example embodiment, an acceleration sensor is polled first. The acceleration sensor reports a high acceleration, for example an acceleration that may be experienced in a car. Thus, it is decided to immediately proceed to the next block and not poll other hard- and/or software blocks, as the reported data from the acceleration sensor indicates that the apparatus is used in a car. This may indicate a high probability that an update of information related to a position may be obtained even without polling other hard- and/or software blocks.

The method proceeds to block 508 to determine a probability for an update of information related to a position being obtained. At block 510 it is decided whether to activate the receiver. The decision may be based on the determined probability and an elapsed time since a last update of the information related to a position. For example, it may be determined that there is a low probability to receive an update of information related to a position. Thus, it is decided at block 510 not to activate the receiver. In an example embodiment, it may be decided to receive information related to a position from a different source, for example from a W-LAN module. In this example, position information may be derived or received from a W-LAN measurement. The decision to receive information related to a position from a different source may be based on received status information. The method then continues at block 502 and a new time when to activate the receiver is decided. At block 504 the timer is started again and at block 506 information is again polled from the hard- and/or software blocks. Based on the new reported information from the polled blocks, a new probability that an update of information related to a position may be obtained is determined at block 508.

In another example, it may be determined at block 508 that there is a low probability to receive an update of information related to a position. It may also be determined that the time since a last update of information related to a position was received is larger than a threshold. For example, it may be determined that no update has been received for 2 hours, such that ephemeris data may become outdated. At block 510, it may then be decided to activate the receiver despite of the determined low probability.

In another example, it may be determined at block 508 that there is a high probability that an update of information related to a position may be received. Thus, it may be decided at block 510 to activate the receiver. The decision may be based on the determined high probability.

At block 512 the receiver is activated and an update of information related to a position is received. For example, a GPS receiver may be activated and an update of ephemeris data may be received.

Methods 400, 500 may be executed by a controller, for example controller 220 of the apparatus 100, 101 in FIG. 2. Controller 220 may be a microprocessor, a microcontroller unit (MCU), a digital signal processor (DSP), or any other structure capable of executing software instructions. Timers described in FIGS. 4 and 5 may be provided by an operating system, for example timers 316 provided by operating system 312, as shown in FIG. 3. Software instructions comprising rules in relation to the polling operation 506 of FIG. 5, for example which hard- and/or software blocks to poll in which order, may be updated by update function 320. Further, software instructions comprising the rules to determine a probability that an update of information related to a position may be obtained may also be updated by update function 320 of FIG. 3. Updates of software instructions may be received through a network connection, for example a connection to a cellular network set up between apparatus 100, 101 and cellular transmitter 112 of FIGURES la, lb. Updates of software instructions may further be received over a W-LAN connection. Updates of software instructions may also be received through a wired interface, for example wired interface 230 of FIG. 2. Further, updates may be installed using a received key or license. A received key or license may also be used to enable already installed software.

Without in any way limiting the scope, interpretation, or application of the claims appearing below, it is possible that a technical effect of one or more of the example embodiments disclosed herein may be that a receiver for a global navigation satellite system may be activated when there is a high probability to receive an update of information related to a position, for example ephemeris data in a GPS system. By avoiding switching on the receiver, power may be saved. This may be relevant in a battery powered apparatus in order to reduce the drain from a battery. Another possible technical effect of one or more of the example embodiments disclosed herein may be that a positioning system that is not based on a global navigation satellite system may be activated, for example when there is a high probability to receive an update of information related to a position, for example from a W-LAN module for W-LAN measurement based position information. Another possible technical effect of one or more of the example embodiments disclosed herein may be a prolonged usage time of a battery powered apparatus. Another possible technical effect of one or more of the example embodiments disclosed herein may be that updated information for a location service may be available in a shorter time when it is needed. Thus, a time to determine a position may be reduced. Another possible technical effect of one or more of the example embodiments disclosed herein may be that an application using position information is ready to be used faster. For example, a navigation application may be ready in a faster way in order to calculate a route from a present position.

Embodiments of the present invention may be implemented in software, hardware, application logic or a combination of software, hardware and application logic. The software, application logic and/or hardware may reside on an apparatus or an accessory to the apparatus. If desired, part of the software, application logic and/or hardware may reside on an apparatus, part of the software, application logic and/or hardware may reside on an accessory. The application logic, software or an instruction set is preferably maintained on any one of various conventional computer-readable media. In the context of this document, a “computer-readable medium” may be any media or means that can contain, store, communicate, propagate or transport the instructions for use by or in connection with an instruction execution system, apparatus, or device.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise any combination of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. A method comprising:
receiving multiple status information of an apparatus;
determining a cumulative probability for an update of information related to a position being obtained based on the multiple status information; and
determining whether to activate a receiver in order to obtain the update of information related to a position based on the determined probability and an elapsed time since a last update of the information related to a position.

2. The method of claim 1, further comprising at least one of:
a) determining a time when to update the receiver in order to obtain the update of information related to a position;
b) wherein information related to a position comprises information related to a process of calculating a position;
c) wherein information related to a position comprises ephemeris data; or
d) wherein information related to a position comprises a reference time.

3-5. (canceled)

6. The method of claim 2, wherein obtaining the information related to a position comprises receiving a signal from a at least one of:
a) satellite of a global positioning system;
b) wherein obtaining the information related to a position comprises receiving information from a short range radio transceiver;
c) wherein receiving status information of an apparatus comprises receiving connectivity information of a local transmitter;
d) wherein receiving status information of an apparatus comprises receiving handover information of a radio receiver;
e) wherein receiving status information of an apparatus comprises receiving information of an active communication profile;
f) wherein receiving status information of an apparatus comprises receiving information of an active profile of the apparatus;
g) wherein receiving status information of an apparatus comprises receiving information on a connected charger; or
h) wherein receiving status information of an apparatus comprises receiving information on a sensor reading.

7-13. (canceled)

14. An apparatus, comprising:
a controller configured to receive multiple status information from the apparatus;
the controller being further configured to determine a cumulative probability for an update of information related to a position being obtained based on the multiple status information;
the controller being further configured to determine whether to activate a receiver in order to obtain the update of information related to a position based on the determined probability and an elapsed time since a last update of the information related to a position; and
the controller being further configured to activate the receiver at the determined time.

15. The apparatus of claim 14, wherein the controller is further configured to determine a time when to update the receiver in order to obtain the update of at least one of:
a) wherein the information related to a position
b) wherein information related to a position comprises ephemeris data; or
c) wherein information related to a position comprises a reference time.

16. The apparatus of claim 15, wherein the apparatus comprises at least one of:
a) wherein the receiver is a receiver of a global navigation satellite system;
b) wherein the apparatus comprises the receiver;
c) wherein the receiver is a short range radio transceiver; or
d) wherein the information related to a position comprises information related to a process of calculating a position.

17-21. (canceled)

22. A computer program, comprising:
code for receiving multiple status information of an apparatus;
code for determining a cumulative probability for an update of information related to a position being obtained based on the multiple status information; and
code for determining a time when to activate a receiver in order to obtain the update of information related to a position based on the determined probability and an elapsed time since a last update of the information related to a position was received when the computer program is run on a processor.

23. The computer program according to claim 22, wherein the computer program is a computer program product comprising a computer-readable medium bearing computer program code embodied therein for use with a computer.

24. A computer-readable medium encoded with instructions that, when executed by a computer, perform:
receiving multiple status information of an apparatus;
determining a probability for an update of information related to a position being obtained based on the multiple status information; and
determining a time when to activate a receiver in order to obtain the update of information related to a position based on the determined cumulative probability and an elapsed time since a last update of the information related to a position was received.

25. An apparatus comprising:
means for receiving multiple status information of an apparatus;
means for determining a cumulative probability for an update of information related to a position being obtained based on the multiple status information; and
means for determining a time when to activate a receiver in order to obtain the update of information related to a position based on the determined probability and an elapsed time since a last update of the information related to a position was received.
